(19) United States
(12) Patent Application Publication
(10) Pub. No.: US 2022/0340187 A1
(43) Pub. Date: Oct. 27, 2022

(54) WHEEL KIT FOR MOVABLE STRUCTURE

(71) Applicant: OverEZ Chicken Coop, LLC, Manheim, PA (US)

(72) Inventors: Henry M. FISHER, Jersey Shore, PA (US); David FISHER, Gordonville, PA (US)

(21) Appl. No.: 17/238,260

(22) Filed: Apr. 23, 2021

(51) Int. Cl. B62B 5/00; B62B 5/06; B62B 3/06; A01K 31/18

(52) U.S. Cl. CPC B62B 5/0086; B62B 5/06; B62B 3/0606; A01K 31/18

(57) ABSTRACT

A wheel kit for moving a structure on a surface. The wheel kit includes first wheel mounting brackets with first wheel assemblies and a second bracket wheel mounting bracket with a second wheel assembly. The first wheel assemblies are movable between first wheel assemblies first positions, in which first wheels engage the surface and raise the structure away from the surface, and first wheel assemblies second positions, in which the first wheels allow the structure to rest on the surface. The second wheel assembly is movable between a second wheel assembly first position, in which a second wheel engages the surface and raises the structure away from the surface, and a second wheel assembly second position, in which the second wheel allows the structure to rest on the surface. The second wheel assembly rotates about the second wheel mounting bracket to allow the second wheel to steer the structure.

### FIELD OF THE INVENTION

The present invention relates generally to a wheel kit which is attached to a structure to facilitate the movement of the structure. In particular, the invention relates to a wheel kit for use with a movable chicken coop.

### BACKGROUND OF THE INVENTION

Raising chickens has become more popular with farmers and nonfarmers alike. Even smaller backyards can comfortably accommodate chickens. With the increased popularity of raising chickens comes an increased demand for chicken coops.

Many chicken coops are on the market. Chicken coops come in a variety of shapes and sizes. As many of the chicken coops are placed in backyards or the like, it is often desirable to move the coops from one location to another for cleaning or as needs change. However, many chicken coops are not mobile, thereby making it difficult or move the chicken coops.

In order to overcome the lack of mobility, various chicken coops have wheels attached thereto. However, in many applications, the wheels are permanently attached, thereby making it difficult to prevent the unwanted movement of the chicken coops. In other applications, the wheels allow for ease of movement only in one line, thereby making it difficult to turn or easily manipulate the movement of the chicken coops in small spaces.

It would, therefore, be beneficial to provide a wheel kit which overcomes the deficiencies of the prior art. In particular, it would be beneficial to have a wheel kit that allows the wheels to engage the surface or ground when movement is desired, but is not in contact with the surface or ground when no movement of the chicken coop is needed. In addition, it would be beneficial to provide a wheel kit or system which allows for the chicken coop to be moved in different directions to facilitate movement of the chicken coop in confined spaces.

### SUMMARY OF THE INVENTION

An embodiment is directed to a wheel kit for moving a structure on a surface. The wheel kit includes first wheel mounting brackets and a second wheel mounting bracket. The first wheel mounting brackets are configured to be mounted to one or more first mounting surfaces of the structure. The second wheel mounting bracket is configured to be mounted to a second mounting surface which is spaced from the one or more second mounting surfaces. First wheel assemblies are mounted in the first wheel mounting brackets, the first wheel assemblies have first wheels. The first wheel assemblies are movable between first wheel assemblies first positions, in which the first wheels engage the surface and raise the structure away from the surface, and first wheel assemblies second positions, in which the first wheels are moved to allow the structure to rest on the surface. A second wheel assembly is mounted in the second wheel mounting bracket, the second wheel assembly has a second wheel. The second wheel assembly is movable between a second wheel assembly first position, in which the second wheel engages the surface and raises the structure away from the surface, and a second wheel assembly second position, in which the second wheel is moved to allow the structure to rest on the surface, the second wheel assembly rotates about the second wheel mounting bracket to allow the second wheel to steer the structure.

An embodiment is directed to a wheel kit for moving a chicken coop on a surface. The wheel kit includes first wheel mounting brackets mounted to one or more first mounting surfaces of the chicken coop and a second wheel mounting bracket mounted to a second mounting surface of the chicken coop which is spaced from the one or more second mounting surfaces. First wheel assemblies are mounted in the first wheel mounting brackets, the first wheel assemblies have first wheels. The first wheel assemblies are movable between first wheel assemblies first positions, in which the first wheels engage the surface and raise the chicken coop away from the surface, and first wheel assemblies second positions, in which the first wheels are moved to allow the chicken coop to rest on the surface. The first wheel assemblies have locking projections and movable locking brackets. The movable locking brackets cooperate with the locking projections to maintain the first wheel assemblies in the first wheel assemblies first positions. A second wheel assembly is mounted in the second wheel mounting bracket, the second wheel assembly has a second wheel. The second wheel assembly is movable between a second wheel assembly first position, in which the second wheel engages the surface and raises the chicken coop away from the surface, and a second wheel assembly second position, in which the second wheel is moved to allow the structure to rest on the surface, the second wheel assembly rotates about the second wheel mounting bracket to allow the second wheel to steer the chicken coop.

Other features and advantages of the present invention will be apparent from the following more detailed description of the illustrative embodiment, taken in conjunction with the accompanying drawings which illustrate, by way of example, the principles of the invention.

### BRIEF DESCRIPTION OF THE DRAWINGS

FIG. 1 is a perspective view of an illustrative structure or chicken coop with wheels of a wheel kit according to the present invention attached, the wheels are shown in a first or extended position.

FIG. 2 is a perspective of the chicken coop of FIG. 1, with the wheels shown in a second or retracted position.

FIG. 3 is an enlarged perspective view of a first mounting bracket with a first wheel assembly mounted therein, the first wheel assembly is shown in the first or extended position.

FIG. 4 is an enlarged perspective view of the first mounting bracket and the first wheel assembly of FIG. 3, the first wheel assembly is shown in the second or retracted position.

FIG. 5 is an enlarged view of the mounting bracket of FIG. 3.

FIG. 6 is an enlarged perspective view of the first wheel assembly of FIG. 3.

FIG. 7 is an enlarged perspective view of a second mounting bracket with a second wheel assembly mounted therein and a handle attached thereto, the second wheel assembly is shown in the first or extended position.

FIG. 8 is an enlarged perspective view of the second mounting bracket of FIG. 7.

FIG. 9 is an enlarged perspective view of the second wheel assembly of FIG. 7.

FIG. 10 is a perspective view of the handle in a first position.

FIG. 11 is a perspective view of the handle in a second position.

FIG. 12 is a perspective view of the handle in engagement with the first wheel assembly.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

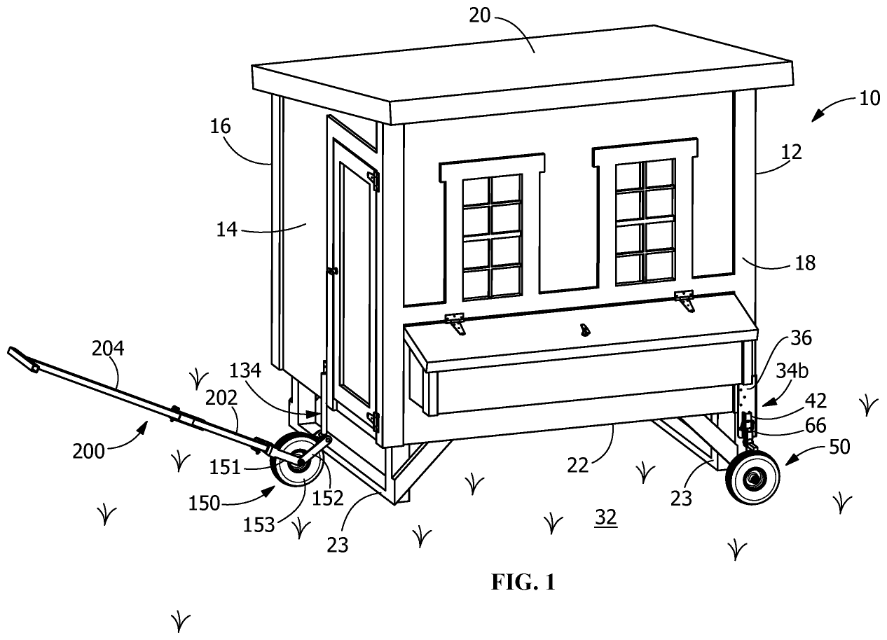

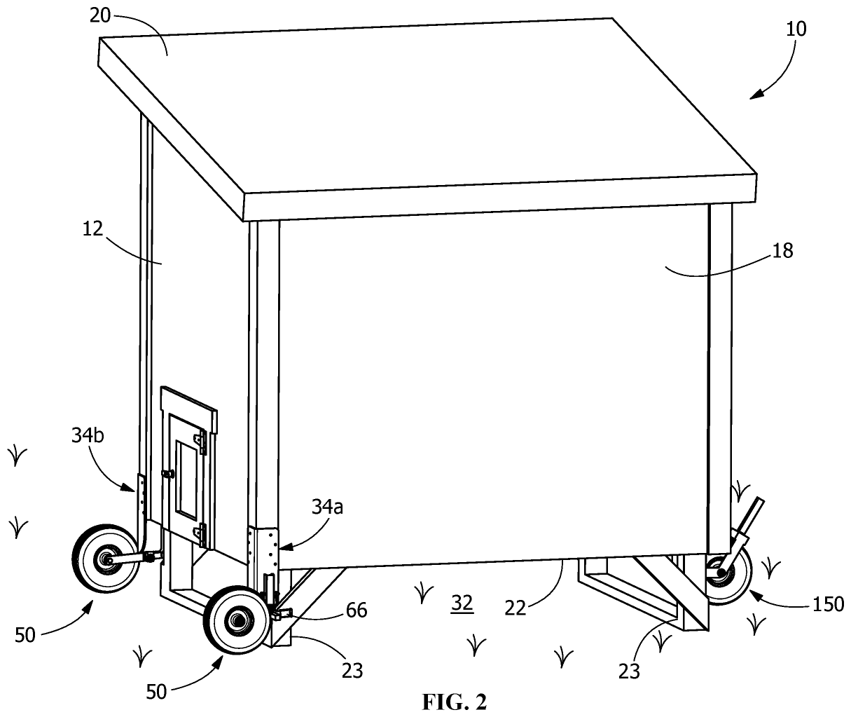

Referring to FIGS. 1 and 2, an illustrative structure or chicken coop 10 is shown. The chicken coop 10 has a first surface or wall 12 and an oppositely facing second surface or wall 14. A third surface or wall 16 and a fourth surface or wall 18 extends between the first surface or wall 12 and the second surface or wall 14. A top surface or roof 20 and a bottom surface or floor 22 with stands 23 are also provided. Although the chicken coop 10 is shown as a rectangular structure, other configurations of chicken coops may be used. In addition, other structures, other than chicken coops may be used.

An illustrative wheel kit for moving the chicken coop 10 or other structure over the ground or surface 32 is shown. The wheel kit includes one or more first wheel mounting brackets 34, one or more first wheel assemblies 50, one or more second wheel mounting brackets 134, one or more second wheel assemblies 150, and a handle member 200. The wheel kit may be mounted on the chicken coop 10 or other structure when purchased, or the wheel kit may be installed or retrofitted to the chicken coop 10 or other structure to provide mobility to an otherwise stationary chicken coop 10 or other structure.

The wheel kit has one or more first wheel mounting brackets 34. In the illustrative embodiment shown, two first wheel mounting brackets 34a, 34b are provided. The first wheel mounting brackets 34 are configured to be mounted to one or more mounting surfaces 12, 14, 16, 18 of the structure 10. In the illustrative embodiment shown one first wheel mounting bracket 34a is mounted to the first surface or wall 12 and the third surface or wall 16 and another first wheel mounting bracket 34b is mounted to the first surface or wall 12 and the fourth surface or wall 18.

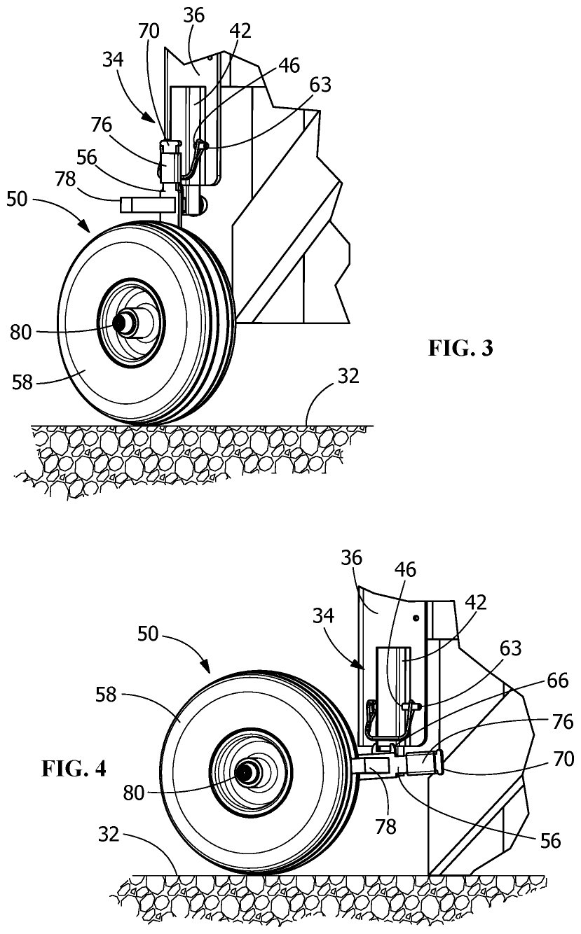

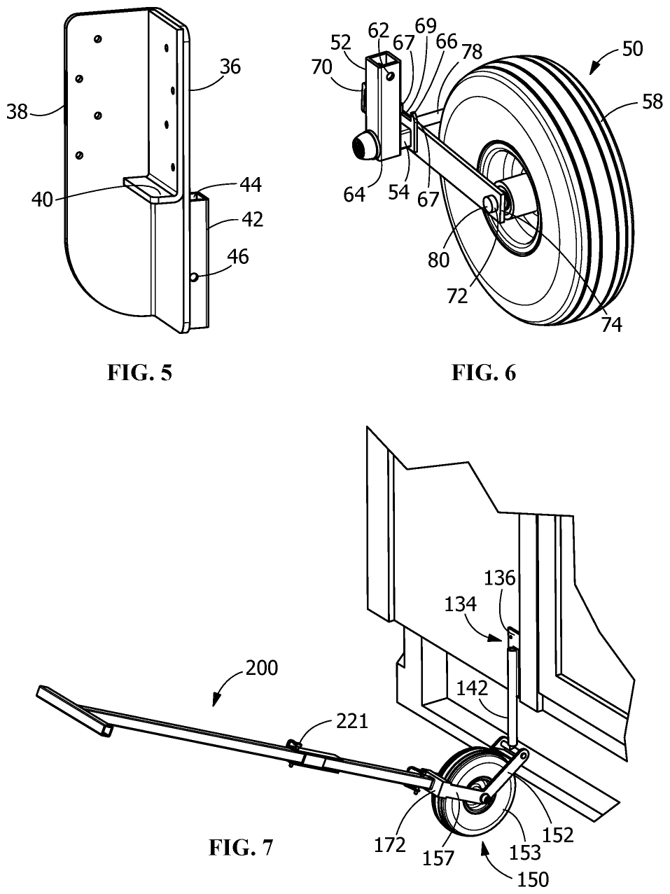

Referring to FIGS. 3 through 5, each of the first wheel mounting brackets 34 have a first wall 36 and a second wall 38. The second walls 38 of the first wheel mounting brackets 34 extend at essentially 90 degrees to the first walls 36. Positioning projections or shoulders 40 (FIG. 5) extend from the first walls 36. The positioning ledges or shoulders 40 extend in a plane which is essentially perpendicular to the planes of the first walls 36 and the second walls 38. The positioning ledges or shoulders 40 are configured to cooperate with the bottom surface or floor 22 or bottom edges of the one or more mounting surfaces 12, 14, 16, 18 of the structure 10 to properly position the first wheel mounting brackets 34 relative to the structure 10.

The first wheel mounting brackets 34 have tubular wheel mounting members 42 which extend from the first walls 36 of the first wheel mounting brackets 34. The tubular wheel mounting members 42 have wheel assembly receiving openings 44 which extend in the longitudinal direction of the first wheel mounting brackets 34. In the illustrative embodiment shown, the tubular wheel mounting members 42 and the wheel assembly receiving openings 44 have generally square cross-sections, but other shapes may be used. Pin mounting or securing openings 46 are provided in opposed walls of the tubular wheel mounting members 42. The securing openings 46 extend into the wheel assembly receiving openings 44.

First wheel assemblies 50 are configured to be mounted in the tubular wheel mounting members 42 of the first wheel mounting brackets 34. As shown in FIG. 6, the first wheel assemblies 50 have tubular mounting rods or members 52, wheel connecting members 54, wheel support or mounting members 56, and wheels 58.

As shown in FIG. 6, the tubular mounting member 52 have a generally square cross-section, but other shapes may be used. The tubular mounting member 52 are configured to be positioned in the wheel assembly receiving openings 44 of the tubular wheel mounting members 42. Pin mounting or securing openings 62 are provided in opposed walls of the tubular mounting member 52. The securing openings 62 extend through the tubular mounting member 52.

The wheel connecting members 54 extend from proximate an end 64 of the tubular mounting member 52 at approximately right angles from the tubular mounting member 52. The wheel connecting members 54 may be mounted to the tubular mounting member 52 by known methods, such as, but not limited to, welding or insertion through a mounting opening (not shown). The wheel connecting members 54 have a generally circular cross-section. Wheel locking projections 66 are provided on the wheel connecting members 54. The wheel locking projections 66 extend in essentially the same direction from the wheel connecting members 54 as does the tubular mounting member 52. The wheel locking projections 66 have side legs 67 and recesses 69 provided between the side legs 67.

The wheel mounting members 56 have member receiving openings (not shown) which are configured to be inserted over the wheel connecting members 54, to allow the wheel mounting members 56 to be rotatable or pivotable relative to the wheel connecting members 54. Wheel mounting openings 72 are provided proximate the opposite end 74 of the wheel mounting members 56. In various embodiments, multiple wheel mounting openings 72 may be provided on the wheel mounting members 56 at different heights.

Movable locking brackets or locking members 76 (FIGS. 3 and 4) are provided on the wheel mounting members 56. The locking brackets 76 are positioned proximate to, but spaced from the member receiving openings. The locking brackets 76 are positioned between the member receiving openings and an end 70 of the wheel mounting members 56. The locking brackets 76 are movable relative to the wheel mounting members 56 between a first position, in which the locking brackets 76 are positioned closer to the end 70 (as shown in FIG. 4), and a second position, in which the locking brackets 76 are positioned closer to the opening 68 (as shown in FIG. 3). The locking brackets 76 are configured to cooperate with the wheel locking projections 66, as will be more fully described.

Positioning members 78 extend from the wheel mounting members 56 at essentially rights angles. The positioning members 78 extend from the wheel mounting members 56 in a direction away from the tubular mounting member 52. The positioning members 78 have a generally square cross-section, but other shapes may be used.

The wheels 58 have axles 80 which extend therefrom. The axles 80 are positioned in the wheel mounting openings 72 of the wheel mounting members 56 and are retained therein by welding, pins, or other known mounting methods.

When assembled the first wheel assemblies 50 are mounted in the first wheel mounting brackets 34. In this position, the tubular mounting rods or members 52 of the first wheel assemblies 50 are positioned in the longitudinally extending wheel assembly receiving openings 44 of the tubular wheel mounting members 42 of the first wheel mounting brackets 34.

The first wheel assemblies 50 are retained in the first wheel mounting brackets 34 by a removable pin 63 which extends through pin mounting or securing openings 46 in the tubular wheel mounting members 42 of the first wheel mounting brackets 34 and pin mounting or securing openings 62 in the tubular mounting member 52 of the first wheel assemblies 50.

The wheel kit has one or more second wheel mounting brackets 134. In the illustrative embodiment shown, one second wheel mounting bracket 134 is provided. The second wheel mounting bracket 134 is configured to be mounted to one or more mounting surfaces 12, 14, 16, 18 of the structure 10. In the illustrative embodiment shown the second wheel mounting bracket 134 is mounted to the second surface or wall 14. The second wheel mounting bracket 134 is mounted to a surface wall which is spaced from or opposed to the surface or wall on which the first wheel mounting bracket 34 is positioned.

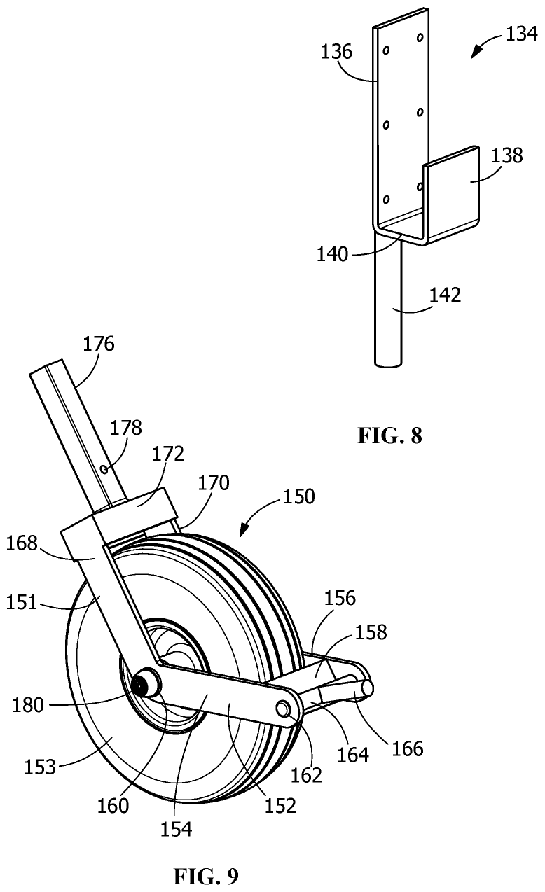

As shown in FIG. 8, the second wheel mounting bracket 134 has a first wall 136 and a second wall 138. The second wall 138 extends essentially parallel to and is spaced from the first wall 136 to form a wall receiving recess 137. A positioning shoulder or wall 140 extends between the first wall 136 and the second wall 138. The positioning shoulder or wall 140 extends in a plane which is essentially perpendicular to the planes of the first wall 136 and the second wall 138. The positioning shoulder or wall 140 is configured to cooperate with a bottom edge of the one or more mounting surfaces 12, 14, 16, 18 of the structure 10 to properly position the second wheel mounting bracket 134 relative to the structure 10.

The second wheel mounting bracket 134 has a tubular wheel mounting member 142 which extends from the first wall 136. The tubular wheel mounting member 142 has a wheel assembly receiving opening 144 which extends in the longitudinal direction of the second wheel mounting bracket 134. The tubular wheel mounting member 142 extends from the first wall 136 to beyond the plane of the positioning shoulder or wall 140. In the illustrative embodiment shown, the tubular wheel mounting member 142 and the wheel assembly receiving opening 144 have generally circular cross-sections, but other shapes may be used.

A second wheel assembly 150 is configured to be mounted in the tubular wheel mounting member 142 of the second wheel mounting bracket 134. As shown in FIG. 9, the second wheel assembly 150 has a mounting frame 152, a handle support frame 151, and a wheel 153.

The mounting projection frame or mounting frame 151 has a generally U-shaped configuration, with a first leg 154, a second leg 156 and a support member 158 which extends between the first leg 154 and the second leg 156. The first leg 154, the second leg 156 and the support member 158 are made from metal or other materials having the desired strength characteristics.

The first leg 154 and the second leg 156 have wheel mounting openings 160 proximate one end and mounting member receiving openings 162 proximate the opposite end. The support member 158 is positioned between the wheel mounting openings 160 and the mounting member receiving openings 162, but closer to the mounting member receiving openings 162.

A mounting member 164 is positioned in the mounting member receiving openings 162. The mounting member 164 is secured to the first leg 154 and the second leg 156 in a manner to allow the mounting member 164 to move or turn in the mounting member receiving openings 162. The mounting member 164 is made from metal or other materials having the desired strength characteristics.

A mounting projection or rod 166 extends from the mounting member 164 in a direction which is essentially perpendicular to the longitudinal axis of the mounting member 164. The mounting projection 166 is made from metal or other materials having the desired strength characteristics. The mounting projection 166 has a generally circular cross-section, but other shapes may be used. The mounting projection 166 is configured to be positioned in the wheel assembly receiving opening (not shown) of the tubular wheel mounting member 142.

The handle receiving projection frame or handle support frame 156 has a generally U-shaped configuration, with a first leg 168, a second leg 170 and a support member 172 which extends between the first leg 168 and the second leg 170. The first leg 168, the second leg 170 and the support member 172 are made from metal or other materials having the desired strength characteristics. The first leg 168 and the second leg 170 have wheel mounting openings proximate the ends that are spaced from the support member 172. In the embodiment shown, the mounting frame 152 and the support frame 151 are one, unitary piece, but other configurations may be used.

A handle mounting projection or rod 176 extends from the support member 172 in a direction which is essentially perpendicular to the longitudinal axis of the support member 172. The handle mounting rod projection is made from metal or other materials having the desired strength characteristics. The handle mounting projection 176 has a generally rectangular cross-section, but other shapes may be used. A securing opening 178 is provided proximate the free end of the handle mounting projection 176. The securing opening 178 extends through the handle mounting projection 176.

The wheel 153 has an axle 180 which extend therefrom. The axle 180 is positioned in the wheel mounting openings 160 of the mounting frame 152 and the wheel mounting openings of the handle support frame 156. The axle 180 and the wheel 158 are retained in position mounting hardware or other known mounting methods. In the illustrative embodiment shown, the mounting frame 152 and the handle support frame 156 are integrally mounted to each other.

When assembled the second wheel assembly 150 is mounted in the second wheel mounting bracket 134. In this position, the mounting projection 166 of the mounting member 164 of the second wheel assembly 150 is positioned in the longitudinally extending wheel assembly receiving opening of the tubular wheel mounting member 142 of the second wheel mounting bracket 134.

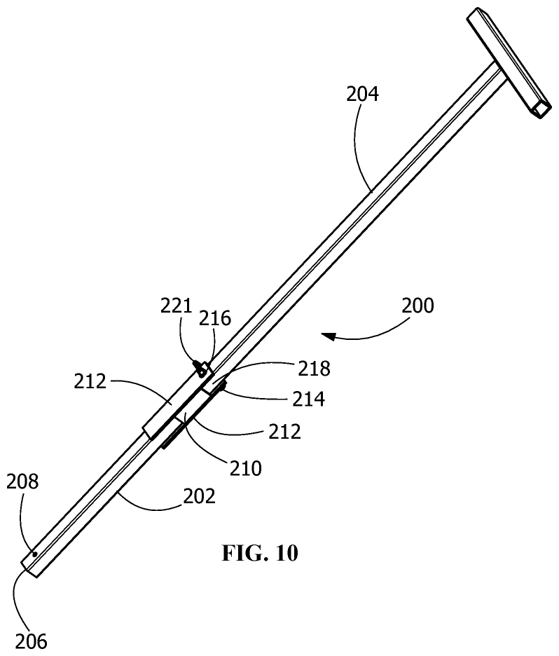

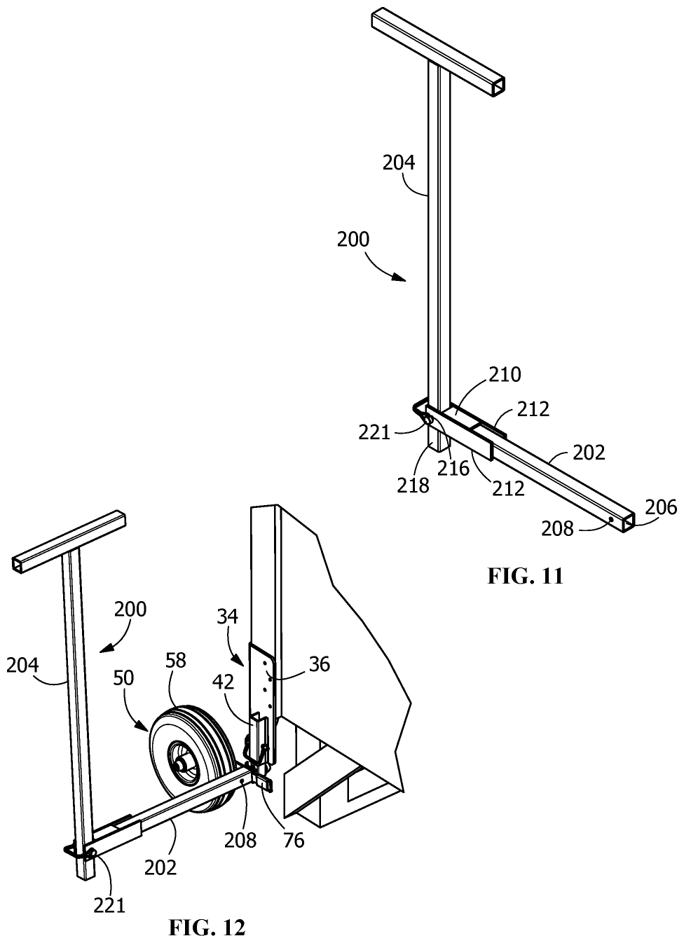

The wheel kit includes a handle member 200 which has a first wheel engaging portion 202 and a second user engaging portion 204. As shown in FIGS. 10 and 11, the first wheel engaging member 202 has a tubular configuration with a handle mounting projection receiving opening 206 which extends in the longitudinal direction of the first wheel engaging member 202. In the illustrative embodiment shown, the first wheel engaging member 202 and the handle mounting projection receiving opening 206 have generally square cross-sections, but other shapes may be used.

A first securing opening 208 is provided proximate one end of the first wheel engaging member 202. The first securing opening 208 extends through the first wheel engaging member 202. At the opposite end of the first wheel engaging member 202 is a second member mounting portion 210. The second member mounting portion 210 has two plates or legs 212 with a slot 214 provided therebetween. Second securing opening 216 extend through the plates 212. The second securing opening 216 of one plate 212 is aligned with the second securing opening 216 of the other plate 212.

The second user engaging member 204 has a tubular configuration. In the illustrative embodiment shown, the second user engaging member 204 has a generally square cross-section, but other shapes may be used. An end 218 of the second user engaging member 204 is configured to be positioned in the slot 214 of the first wheel engaging member 202. A third securing opening (not shown) is provided proximate the end 218 of the first wheel engaging member 202. The third securing opening extends through the second user engaging member 204.

With the first wheel mounting brackets 34 and the second wheel mounting bracket 134 properly mounted on the chicken coop 10 and the first wheel assemblies 50 and the second wheel assemblies 150 positioned in the respective brackets 34, 134, the wheel kit can be used to move the chicken coop 10 as desired. In the illustrative embodiment shown, the first wheel mounting brackets 34 are two first wheel mounting brackets 34 positioned as opposite corners of a respective mounting surface 32 of the one or more mounting surfaces 12, 14, 16, 18 of the structure or chicken coop 10.

The first wheel assemblies 50 are movable between first wheel assemblies first positions, as shown in FIGS. 1 and 3, in which the first wheels 58 engage the surface 32 and raise the structure 10 away from the surface 32, and first wheel assemblies second positions, as shown in FIGS. 2 and 4, in which the first wheels 58 are moved to allow the structure 10 to rest on the surface 32.

The second wheel assembly 150 is also movable between a second wheel assembly first position, as shown in FIGS. 1 and 7, in which the second wheel 158 engages the surface 32 and raises the structure 10 away from the surface 32, and a second wheel assembly second position, as shown in FIG. 2, in which the second wheel 158 is moved to allow the structure 10 to rest on the surface 32. In the second wheel assembly first position, the second wheel assembly 150 rotates about the second wheel mounting bracket 134 to allow the second wheel 158 to steer the structure 10.

When it is desired to have the structure or coop 10 stationary, the first wheel assemblies 50 and the second wheel assemblies 150 are retained in their respective second positions. When it is desired to move the structure or coop 10, the first wheel assemblies 50 and the second wheel assemblies 150 must be move to their respective second positions.

In order to move the first wheel assemblies 50 from the second position to the first position, the handle member 200 is used. In order to provide the proper positioning of the handle member 200, the first wheel engaging portion 202 of the handle member 200 is moved or rotated to form an L-shaped member, in which the first wheel engaging portion 202 is positioned essentially perpendicular to the second user engaging portion 204. The third securing opening of the second user engaging portion 204 is positioned in alignment with the first securing opening 208 and the second securing opening 216 of the first wheel engaging portion 202. A securing pin 221 is positioned through the openings 208, 216 to retain the handle member 200 in the wheel rising position, as shown in FIGS. 11 and 12.

With the handle member 200 position in the wheel rising position, the receiving opening 206 of the first wheel engaging portion 202 is moved into engagement with a respective positioning member 76 of one of the first wheel assemblies 50. The operator engages and rotates the second user engaging portion 204. This causes the first wheel engaging portion 202 to move into the respective positioning member 76 of one of the first wheel assemblies 50. As this occurs, the positioning member 76 causes the wheel mounting member 56 to pivot about the wheel connecting member 54. The movement of the wheel mounting member 56 causes the wheel 58 to engage the surface 32 and exert a force thereon, resulting in the structure or coop 10 being lifted from the surface 32 as the wheel 58 continues to rotate or pivot about the wheel connecting member 54.

The rotation continues until the wheel mounting member 56 is positioned in line with the mounting members 52 of the first wheel assembly 50. In this position, the movable locking member 76 is moved from the locking member first position to the locking member second position. In the locking member section position, the locking member 76 are positioned in the recesses 69 of the wheel locking projection 66. In this position, the legs 67 prevents the rotation of the locking member 76 and the wheel mounting member 56 relative to the wheel connecting member 54. Therefore, the locking member 76 cooperates with the wheel locking projection 66 to retain the first wheel assembly 50 in the second or raised position. With the first wheel assembly 50 in the second or raised position, the handle member 200 is removed.

The operation described above is repeated for the second first wheel assembly 50. This allows both first wheel assemblies 50 to be positioned in the second or raised position.

With the first wheel assemblies 50 properly raised, the first wheel engaging portion 202 of the handle member 200 is moved or rotated to form a straight member with the second user engaging portion 204. In this position, the third securing opening of the second user engaging portion 204 is positioned in alignment with the first securing opening 208 and the second securing opening 216 of the first wheel engaging portion 202. The securing pin 221 is positioned through the openings 208, 216 to retain the handle member 200 in a coop moving position, as shown in FIGS. 7 and 10.

With the handle member 200 position in the coop moving position, the receiving opening 206 of the first wheel engaging portion 202 is moved into engagement with the handle mounting projection 176 of one of the second wheel assembly 150. The operator engages and pushes down on the second user engaging portion 204. This causes the handle member 200 to depress the handle support frame 156. As the handle support frame 156 is depressed, the second wheel assembly 150 is pivoted about the second wheel 158, causing the mounting frame 152 and the mounting projection 166 to move upward, away from the surface 32 to the second position. As this occurs, the mounting projection 166 causes the wheel mounting member 142, the second wheel mounting bracket 134 and the coop 10 to move upward, or lifted away from the surface 32.

With all wheel assemblies 50, 150 being moved to the second position, the coop or structure 10 is able to move freely on the surface 32. In the second wheel assembly second position, the second wheel assembly 150 can rotate about the second wheel mounting bracket 134 to allow the second wheel 158 to steer the coop or structure 10.

When movement is complete, the handle member 200 is released, allowing the second wheel assembly 150 to return to the second position. The handle member 200 is then removed and transformed into the L-shaped member as described above. The locking members 76 of the first wheel assemblies 50 is moved out of the recess 69 to their first positions and the handle member 200 is used to reverse the movement of the first wheel assemblies 50, to allow the first wheel assemblies to move back to the second position. In the second position, the coop or structure 10 is prevented from movement relative to the surface 10.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A wheel kit for moving a structure on a surface, the wheel kit comprising:
first wheel mounting brackets, the first wheel mounting brackets configured to be mounted to one or more first mounting surfaces of the structure;
a second wheel mounting bracket, the second wheel mounting bracket configured to be mounted to a second mounting surface which is spaced from the one or more second mounting surfaces;
first wheel assemblies mounted in the first wheel mounting brackets, the first wheel assemblies have first wheels, the first wheel assemblies are movable between first wheel assemblies first positions, in which the first wheels engage the surface and raise the structure away from the surface, and first wheel assemblies second positions, in which the first wheels are moved to allow the structure to rest on the surface;
a second wheel assembly mounted in the second wheel mounting bracket, the second wheel assembly has a second wheel, the second wheel assembly is movable between a second wheel assembly first position, in which the second wheel engages the surface and raises the structure away from the surface, and a second wheel assembly second position, in which the second wheel is moved to allow the structure to rest on the surface, the second wheel assembly rotates about the second wheel mounting bracket to allow the second wheel to steer the structure.

2. The wheel kit as recited in claim 1, wherein the first wheel assemblies have locking projections and movable locking brackets, wherein the movable locking brackets cooperate with the locking projections to maintain the first wheel assemblies in the first wheel assemblies first positions.

3. The wheel kit as recited in claim 1, wherein the first wheel mounting brackets have positioning projections, the positioning projections are configured to cooperate with bottom edges of the one or more first mounting surfaces of the structure to properly position the first wheel mounting brackets.

4. The wheel kit as recited in claim 1, wherein the second wheel mounting bracket has a positioning shoulder, the positioning shoulder is configured to cooperate with a bottom edge of the second mounting surface of the structure to properly position the second wheel mounting bracket.

5. The wheel kit as recited in claim 1, wherein the first wheel assemblies have mounting rods and first wheel support members on which the first wheels are mounted, the first wheel support members are pivotally mounted to the mounting rods.

6. The wheel kit as recited in claim 5, wherein the mounting rods of the first wheel assemblies are positioned in longitudinally extending openings of tubular members of the first wheel mounting brackets when the first wheel assemblies are mounted to the first wheel mounting brackets.

7. The wheel kit as recited in claim 6, wherein the first wheel assemblies are retained in the first wheel mounting brackets by a removable pin which extends through pin mounting openings in the tubular members of the first wheel mounting brackets and pin mounting openings in the mounting rods of the first wheel assemblies.

8. The wheel kit as recited in claim 7, wherein the first wheel mounting brackets are two first wheel mounting brackets positioned as opposite corners of a respective second mounting surface of the one or more second mounting surfaces.

9. The wheel kit as recited in claim 1, wherein the second wheel assembly has a mounting projection extending from a mounting projection frame which is attached to an axle of the second wheel and a handle receiving projection extending from a handle receiving projection frame which is attached to the axle of the second wheel, the mounting projection frame and the handle receiving projection frame are integrally mounted to each other.

10. The wheel kit as recited in claim 9, wherein the mounting projection of the second wheel assembly is positioned in a longitudinally extending opening of a tubular member of the second wheel mounting bracket when the second wheel assembly is mounted to the second wheel mounting bracket.

11. The wheel kit as recited in claim 10, wherein a handle is positioned on the handle receiving projection of the second wheel assembly.

12. The wheel kit as recited in claim 11, wherein the handle receiving projection is positioned in a longitudinally extending projection opening of the handle when the handle is positioned on the handle receiving projection.

13. The wheel kit as recited in claim 12, wherein the handle is retained on the handle receiving projection by a removable pin which extends through pin mounting openings in the handle and pin mounting openings in the handle receiving projection.

14. The wheel kit as recited in claim 13, wherein the handle has a first portion and a second portion, the second portion is rotatable relative to the first portion, the projection opening of the handle is provided in the second portion, wherein with the handle rotated to form an L-shaped member, the projection opening is inserted onto a rotation projection of a respective first wheel assembly of the first wheel assemblies to allow the respective first wheel assembly to be moved between the first wheel assemblies first position and the first wheel assemblies second position.

15. A wheel kit for moving a chicken coop on a surface, the wheel kit comprising:
first wheel mounting brackets, the first wheel mounting brackets mounted to one or more first mounting surfaces of the chicken coop;
a second wheel mounting bracket, the second wheel mounting bracket mounted to a second mounting surface of the chicken coop which is spaced from the one or more second mounting surfaces;
first wheel assemblies mounted in the first wheel mounting brackets, the first wheel assemblies have first wheels, the first wheel assemblies are movable between first wheel assemblies first positions, in which the first wheels engage the surface and raise the chicken coop away from the surface, and first wheel assemblies second positions, in which the first wheels are moved to allow the chicken coop to rest on the surface, the first wheel assemblies have locking projections and movable locking brackets, the movable locking brackets cooperate with the locking projections to maintain the first wheel assemblies in the first wheel assemblies first positions;
a second wheel assembly mounted in the second wheel mounting bracket, the second wheel assembly has a second wheel, the second wheel assembly is movable between a second wheel assembly first position, in which the second wheel engages the surface and raises the chicken coop away from the surface, and a second wheel assembly second position, in which the second wheel is moved to allow the structure to rest on the surface, the second wheel assembly rotates about the second wheel mounting bracket to allow the second wheel to steer the chicken coop.

16. The wheel kit as recited in claim 15, wherein the first wheel assemblies have mounting rods and first wheel support members on which the first wheels are mounted, the first wheel support members are pivotally mounted to the mounting rods, the locking projections are provided on the mounting rods and the movable locking projections are provided on the first wheel support members.

17. The wheel kit as recited in claim 16, wherein the mounting rods of the first wheel assemblies are positioned in longitudinally extending openings of tubular members of the first wheel mounting brackets.

18. The wheel kit as recited in claim 17, wherein the first wheel assemblies are retained in the first wheel mounting brackets by a removable pin which extends through pin mounting openings in the tubular members of the first wheel mounting brackets and pin mounting openings in the mounting rods of the first wheel assemblies.

19. The wheel kit as recited in claim 18, wherein the second wheel assembly has a mounting projection extending from a mounting projection frame which is attached to an axle of the second wheel and a handle receiving projection extending from a handle receiving projection frame which is attached to the axle of the second wheel, the mounting projection frame and the handle receiving projection frame are integrally mounted to each other.

20. The wheel kit as recited in claim 19, wherein a handle is positioned on the handle receiving projection of the second wheel assembly, the handle has a first portion and a second portion, the second portion is rotatable relative to the first portion, a projection opening of the handle is provided in the second portion.
